(19) United States
(12) Patent Application Publication
(10) Pub. No.: US 2001/0002007 A1
(43) Pub. Date: May 31, 2001

(54) EASY-CHANGE FUEL FILTER

(75) Inventors: FRANK J. ZUPAN, BANNING, CA (US); TERRANCE D. ZUPAN, BANNING, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(73) Assignee: FRANK J. ZUPAN

(21) Appl. No.: 09/245,206

(22) Filed: Feb. 5, 1999

Related U.S. Application Data
(60) Provisional application No. 60/073,965, filed on Feb. 6, 1998.

(51) Int. Cl. B01D 35/34

(52) U.S. Cl. 210/448

(57) ABSTRACT

A fuel filter assembly having a main body defining a cylindrical cavity that can receive a cylindrical fuel filter element. One end of the main body has a nipple that is adapted to be attached to a fuel line. The other end of the main body has an opening that is sized so as to permit the fuel filter element to be positioned within the cylindrical cavity. A compression member is also adapted to be positioned within the opening so as to seal the opening when the fuel filter element is positioned within the cavity of the main body. The compression member includes a second nipple adapted to attach to a fuel line so as to allow fuel to flow through the central cavity. A threaded collar engages with the main body so as to retain the compression member in the opening of the main body. The fuel filter element can therefore be replaced by simply unthreading the collar and removing the compression member and extracting the existing fuel filter.

### Related Applications

The present application claims the benefit of U.S. Provisional patent application Ser. No. 60/073,965, filed Feb. 6, 1998, entitled EASY CHANGE FUEL FILTER.

### BACKGROUND OF THE INVENTION

The present invention relates to a fuel filter, and in particular relates to a fuel filter that may be easily and quickly serviced and changed.

Fuel filters are devices that are used in fuel or oil lines to clean impurities from the fuel. Typically, fuel flows through the fuel filter as it travels through the fuel line. The filter traps and holds particles and other impurities.

After a certain amount of use, the fuel filters must be replaced or they may need to be serviced or inspected. Unfortunately, removal and change of a fuel filter is typically a dirty and inconvenient process. The user must usually use a tool to remove the filter, which may be inconvenient and impractical if the user does not have access to tools. Further, the fuel filter must be entirely removed from the fuel line so that a new filter may be installed and attached to the fuel lines. This is also inefficient and may be messy, as fuel or oil may spill from the fuel lines when the fuel filter is removed.

There is therefore a need for a fuel filter that may be easily and quickly replaced. Preferably, the filter may be replaced or serviced without the use of tools and without having to disconnect the fuel or oil lines from the filter and/or the engine.

### SUMMARY OF THE INVENTION

The aforementioned needs are satisfied by the present invention, which is an easy change fuel filter that comprises, in one embodiment, of several interconnecting items, including a filter element, and a seal. The fuel filter also includes a canister-like main body which has an inlet nipple having a hole which communicates with the canister. This serves as the access for fuel entry. A fuel line is attached to the nipple to supply fuel to the filter.

The fuel exits the filter through another nipple which is located at an exit end of the assembly. The nipple can be a “AN” style, a barb-type or push-on type (the latter two types would require a hose clamp). The exit end of the canister is internally or externally threaded which allows, in one embodiment, an O-ringed nipple to seal against the fuel filter element via a threaded compression collar. The O-ring acts as a seal between the compression nipple and the canister with the collar nut applying the pressure needed via tightening of the collar unto the canister body. This sealing method greatly facilitates a leak-free fit.

The retainer ring allows the assembly to be separated by turning the collar nut counter-clockwise and exposing the filter without having to disconnect either the inlet or outlet fuel lines. The compression nipple has a hole through it for fuel to exit into the fuel system from the fuel filter. The exit may be made to accept an “AN” fitting, as is known to those skilled in the art, or made like a hose barb so a fuel line may be pushed-on and clamped securely with a hose band clamp to prevent leakage.

The easy-change fuel filter may be used wherever an in-line fuel or oil filter is required. No tools are needed to change the filter element and it can be changed in a matter of seconds by even a novice do-it-yourselfer or mechanic by simply turning the collar nut to open or close the canister chamber which encloses the filter element. The filter element can be varied according to different micron ratings. The retainer ring keeps the collar nut attached to the compression nipple so that the filter may be changed without removing any parts from the fuel line. Neither the inlet line nor the exit line need to be disconnected to service the filter.

### BRIEF DESCRIPTION OF THE DRAWINGS

These and other features of the invention will now be described with reference to the drawings of a preferred embodiment which is intended to illustrate and not to limit the invention, and in which:

FIG. 1 is a perspective view of a preferred embodiment of the easy change fuel filter in accordance with the present invention; and

FIG. 2 is a perspective view illustrating the various components of the fuel filter illustrated in FIG. 1.

### DETAILED DESCRIPTION OF THE PREFERRED EMBODIMENT

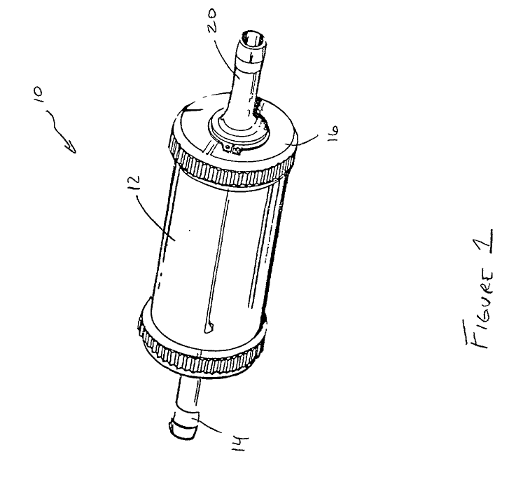

FIG. 1 illustrates an assembled fuel filter 10 in accordance with a preferred embodiment of the present invention. The fuel filter 10 includes an outer casing or main body 12 having a generally cylindrical shape. An inlet nipple 14 is connected to a first end of the main body 12. The inlet nipple 14 is configured to couple with a fuel line (not shown) to allow fuel to flow into the fuel filter 10. A collar nut 16 is removably secured to a second end of the main body 12. The collar nut 16 includes an outlet nipple 20 so that the outlet nipple 20 removably secures to the main body 12. The outlet nipple 20 extends outward from the second end of the main body 12 and is configured to couple with a fuel line (not shown) for fuel flow out of the fuel filter 10, as describe more fully below.

The inlet and outlet nipples 14 and 20, respectively, may be a “AN” style, a barb-type or push-on type, or any other type of attachment known to those skilled in the art. The nipples 14 and 20 preferably allow fuel lines of vehicles, either rubber or metal lines, to be attached to the fuel filter 10 so that fuel from the fuel tank of the vehicle must travel through the fuel filter 10 before being provided to the vehicle engine in a manner known in the art.

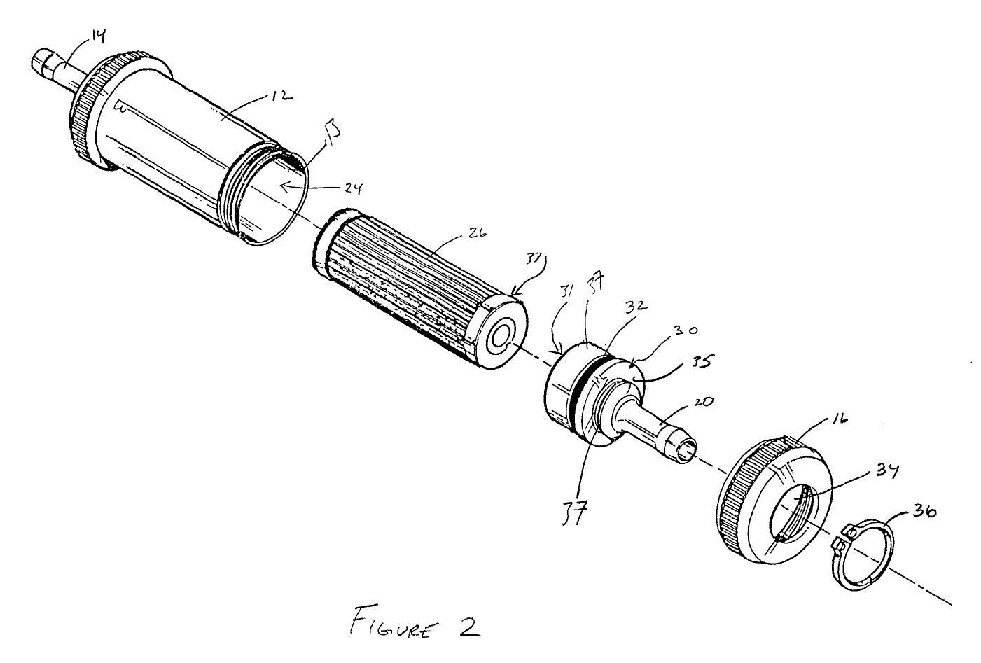

FIG. 2 illustrates the various components of the fuel filter 10 in a disassembled or exploded state. The main body 12 defines a cylindrical cavity 24 which communicates with the nipple 14. A filter element 26 preferably has a shape that substantially conforms to the shape of the cavity 24. The filter element is configured to be slidably inserted into the cavity 24. The fuel filter element 26 is similar in construction to fuel filter elements of the prior art. In general, the fuel filter element includes a porous filter material that will allow the fuel to flow therethrough. However, foreign particles, such as dirt, carbon, and other contaminants, will be trapped within the fuel filter thereby allowing only substantially filtered fuel to travel out of the filter through the outlet nipple 20 to the vehicle engine (not shown).

A compression member 30, which includes the outlet nipple 20, is configured to be slidably inserted into the cavity 24. An O-ring 32 surrounds one portion of the compression member 30. In particular, the compression member 30 defines an inner cavity 31 that is adapted to be positioned about a first end 33 of the fuel filter element 26. The outlet nipple 20 is positioned in substantially the center of the front face 35 of the compression member 30 and communicates with the inner cavity 31 so as to allow fuel filtered by the filter element 26 to exit the fuel filter 10 through the outlet nipple 20 in the manner that will be described in greater detail below.

Referring to FIG. 2, one end of the main body 12 is threaded. It will be appreciated that the threads could be either on the exterior surface of the main body 12 or the interior surface within the cavity 24. The collar nut 16 is configured to be screwed onto the threaded end of the main body 12. An aperture 34 extends through the collar nut 16. The aperture 34 is configured to receive therethrough the nipple 20 on the compression member 30. A retainer ring 36 may be slidably inserted over the outlet nipple 20. The retainer ring 36 may be a standard ring of the type known to those skilled in the art, or the retainer ring 36 may be manufactured by stamping from any heat treatable steel or of preheat-treated spring steel alloy.

The fuel filter 10 is assembled as follows. The filter element 26 is first inserted into the cavity 24 within the main body 12. The compression member 30 is then inserted into the cavity over the filter element 26 so that the outlet nipple 20 extends out of the cavity 24 in a direction away from the filter element 26. The collar nut 16 is then inserted over the compression member 30 so that the outlet nipple 20 extends through the aperture 34 in the collar nut 16. The collar nut 16 may then be screwed on to the main body 12 by way of the threads. Preferably, the collar nut 16 is tightened sufficiently to compress the filter element 26 and compression member 30 within the cavity 24. The retaining ring 36 may then be inserted over the outlet nipple 20 and engage with a channel 37 formed on the compression member 30 about the outlet nipple 20 to seal any space that exists between the aperture 34 and the outlet nipple 20 and to prevent the compression member 30 from moving with respect to the collar 16.

As discussed, an inlet fuel flow line (not shown) is connected to the inlet nipple 14. An outlet fuel flow line (not shown) is also connected to the outlet nipple 20. Fuel is then flowed into the fuel filter 10 from the fuel line through the inlet nipple 14. Fuel then flows through the filter element 26 which acts to remove particles and other impurities from the fuel. Fuel flows out of the fuel filter 10 through the outlet nipple 20 and into the outlet fuel line.

The O-ring 32 and the retaining ring 36 seal the fuel filter 10 against leakage. In particular, the O-ring 32 is preferably positioned about the outer surface 37 of the compression member 30 so as to engage with the inner surfaces 13 of the main body 12. Preferably, the compression member 30 is sized so as to be compression fitted within the inner cavity 24 of the main body 12. The O-ring 32 preferably has a larger diameter than the inner cavity 24 so that it is compressed and thereby seals the compression member 30 inside of the inner cavity 24 of the main body 12 so that fuel can only leave the main body 12 via the outlet nipple 20 as described above. The collar nut 16 is designed to secure the compression member 30 within the main body 12. Preferably, the retaining ring 36 retains the compression member 30 in a desired sealed position with respect to the collar member 16 and the main body 12.

After a certain amount of use, the filter element may become worn so that it needs to be replaced. Alternatively, the filter element may require servicing or examination. This is easily accomplished by unscrewing the collar nut 16 from one end of the main body 12 and extracting the compression member 30 from the main body 17. The filter element 26 may then be removed from the cavity 24 and replaced with a new filter element or serviced.

It will be appreciated that the fuel lines that are connected to the inlet nipple 14 and the outlet nipple 20 need not be disconnected from the fuel filter 10 during replacement of the fuel filter 10. Furthermore, the filter element 26 can be replaced without the use of any tools, as the collar nut is preferably removable with a user's hands. Hence, replacement of the fuel filter may be accomplished quickly and easily.

The fuel filter 10 may be made of any non-reactive material for fuel or oil. The parts may be made by molding, casting, stamping, extruding, machining and/or any other metal forming process capable of attaining the desired shape, or a combination of any or all of the above mentioned processes. Preferably, the fuel filter 10 may be made of a high gloss metal, such as billet aluminum, for appearance purposes.

Although the preferred embodiment of the present invention has shown, described, and pointed out the fundamental novel features of the invention as applied to these embodiments, it will be understood that various omissions, substitutions, and changes in the form of the detail of the device illustrated, may be made by those skilled in the art without departing from the spirit of the present invention. Consequently, the scope of the invention should not be limited to the foregoing discussion, but should be defined by the appended claims.

What is claimed is:

1. A fuel filter assembly, comprising:
an outer casing defining an internal cavity;
an inlet on the outer casing, the inlet defining a fluid flow path into the internal cavity of the outer casing wherein the inlet is configured to couple with a fuel line so that fuel may flow through the outer casing;
an outlet on the outer casing, the outlet defining a fluid flow path into the internal cavity of the outer casing wherein the outlet is configured to couple with a fuel line so that fuel may flow through the outer casing; and
a filter element positioned within the internal cavity of the outer casing, wherein the outer casing is adapted so that the filter element may be inserted into and removed from the internal cavity of the outer casing while a fuel line remains coupled to the inlet and a fuel line remains coupled to the outlet.

2. The fuel filter assembly of claim 1, wherein the inlet comprises a first nipple and the outlet comprises a second nipple.

3. The fuel filter assembly of claim 2, wherein the second nipple is removably mounted to the outer casing, and wherein an opening is created in the outer casing when the second nipple is removed therefrom, the opening sized to receive the filter therethrough.

4. The fuel filter assembly of claim 3, additionally comprising a collar nut removably coupled to the outer casing, wherein the collar nut secures the second nipple to the housing.

5. The fuel filter assembly of claim 2, wherein the first nipple is fixedly attached to the outer casing.

6. The fuel filter assembly of claim 3, wherein the second nipple may be removed from the outer casing without the use of tools.

7. A fuel filter assembly, comprising:
a housing defining an internal cavity;
a first nipple coupled to a first end of the housing, the first nipple defining an internal channel communicating with the internal cavity, wherein the first nipple is configured to be connected to a fuel line to thereby create a fluid communication path between the fuel line and the internal cavity;
a second nipple coupled to a second end of the housing, the second nipple defining an internal channel communicating with the internal cavity, wherein the second nipple is configured to be connected to a fuel line to thereby create fluid communication path between the fuel line and the internal cavity; and
wherein the second nipple is removably coupled to housing so that the second nipple may be removed from the housing to provide access to the internal cavity while a fuel line remains connected to the first nipple and a fuel line remains connected to the second nipple.

8. The fuel filter assembly of claim 7, additionally comprising a filter element positioned within the internal cavity.

9. The fuel filter assembly of claim 7, wherein the second nipple is coupled to the housing through a threaded connection.

10. The fuel filter assembly of claim 7, additionally comprising a collar nut removably coupled to the housing, wherein the collar nut secures the second nipple to the housing.

11. The fuel filter assembly of claim 10, additionally comprising an O-ring between the collar nut and the second nipple, the O-ring configured to provide a seal between the collar nut and the second nipple.

12. The fuel filter assembly of claim 7, wherein the second nipple may be removed from the housing without the use of tools.

13. A fuel filter assembly adapted to be attached in series in the fuel line of a vehicle so as to filter contaminants out of the fuel prior to delivery of the fuel to the vehicle's engine, the assembly comprising:
a main body defining an inner cavity, wherein a first end of the main body includes a first nipple adapted to be coupled to the fuel line so as to allow for fuel flow through the inner cavity and wherein a second end of the main body defines an opening;
a filter element that can be positioned into and removed from the inner cavity of the main body through the opening;
a compression member adapted to be positioned within the opening of the main body so as to seal the inner cavity of the main body, wherein the compression member includes a second nipple adapted to be coupled to the fuel line so as to allow fuel flow through the inner cavity of the main body and wherein the compression member is compression fitted into the opening and is removable therefrom so as to allow installation and removal of the filter element from the inner cavity through the opening by removal of the compression member from the opening in the main body.

14. The fuel filter of claim 13, further comprising a securing member that engages with the first end of the main body so as to secure the compression member in the opening of the main body.

15. The fuel filter of claim 14, wherein the outer surface of the main body is threaded and the securing member comprises a threaded collar nut having an opening positioned therein, wherein the threaded collar nut can be threadably secured to the first end of the main body so that the second nipple of the compression member extends through the opening in the threaded collar nut and so that the threaded collar nut prevents the compression member from being removed from the opening.

16. The fuel filter of claim 15, further comprising a retainer and wherein a channel is formed about the second nipple that is adapted to receive the retainer so that when the collar nut is secured to the first end of the main body with the second nipple extending through the opening in the threaded collar nut, the retainer engages with the compression member so as to prevent movement of the compression member with respect to the threaded collar nut.

17. The fuel filter of claim 13, wherein the compression member includes a sealing ring that is positioned about an outer surface of the compression member so as to engage the inner surface of the cavity defined by the main body so that the opening is sealed when the compression member is positioned in the opening.

18. The fuel filter of claim 17, wherein the inner cavity of the main body is cylindrical in shape and the compression member has an O-ring of a diameter that is slightly greater than the inner diameter of the cylindrical inner cavity so that positioning of the compression member within the opening results in compression of the O-ring thereby sealing the opening.
